(19) United States
(12) Patent Application Publication
(10) Pub. No.: US 2006/0048653 A1
(43) Pub. Date: Mar. 9, 2006

(54) Peeling machine

(76) Inventor: Egil Norrvik, Dagsmark (FI)

Correspondence Address: YOUNG & THOMPSON, 745 SOUTH 23RD STREET, 2ND FLOOR, ARLINGTON, VA, 22202, US

(21) Appl. No.: 11/218,626

(22) Filed: Sep. 6, 2005

(30) Foreign Application Priority Data
Sep. 3, 2004 (FI) 20045325

(51) Int. Cl. A23N 7/00

(52) U.S. Cl. 99/623

(57) ABSTRACT

The present invention relates to a peeling machine, which refers to a machine for industrial peeling of root vegetables, fruits and the like with cutting blades. This peeling machine comprises a frame having a circular outer drum and inner drum. These together with a bottom form an enclosed peeling space, at the bottom of which there are blades provided with rotating peeling plates. Below the peeling plates, a suction arrangement is mounted which sucks and removes peeling waste to enable water-free peeling. For moving the peeling product forwards in the machine, a push plate with a reel is used that moves the peeling product forwards from the inlet of the peeling machine over one or more peeling plates towards the outlet of the peeling machine.

### TECHNICAL AREA

The present invention relates to a peeling machine, which refers to a device for mechanical peeling of root vegetables, such as potatoes and the like products. The device is also suitable for peeling long and narrow root vegetables, such as carrots, as well as fruits. A peeling machine according to the present construction utilizes rotating cutting blades in the peeling.

### PRIOR ART

It is long known and well-tried to mechanically peel root vegetables, such as potatoes, with mechanical knife peeling devices. Such devices have a circular casing surface that forms a container for the product to be peeled. In order to carry out the peeling, this casing surface is provided with rotating cutting blades in its inside. The peeling machine according to publication CH 505 564, for instance, has a circular casing as well as a basket-like container the inside of which is, all the way round, provided with vertical blades. Also the rotating round bottom of the peeling machine can be provided with blades.

The peeling machine according to publication U.S. Pat. No. 4,143,593 has a tight circular casing the inside of which is, all the way round, provided with round rotating plates with knives, placed on edge along the inside.

These known peeling machines are what are called portion-peeling machines, which are filled with a given amount of root vegetables (a portion) that is subsequently peeled, after which the peeling machine is emptied. A portion scale is needed to portion the root vegetables. Since the portion is emptied at one time, the after-cleaning of the peeled product becomes difficult, because a relatively large number of peeled products are to be attended to at the same time. This type of peeling machine also requires plenty of water in the peeling, which means that there will be a large amount of waste water that causes an environmental load.

Another type of knife peeling device is shown for example in publication DE 102 30 627. This peeling machine has a circular casing with a rotating bottom plate provided with cutting blades. This peeling machine has a propeller wheel supplying the product to be peeled around the container. The peeling machine also has a throw member moving the product about during the peeling and finally attending to the discharge of the product from the peeling machine via an outlet opening. This peeling machine has thus a continuous product flow-through. A throw member according to this solution causes, however, impact damages (what are called blue spots) on the product to be peeled. This type of peeling machine also requires a relatively large amount of water in the peeling.

### PRESENTATION OF THE PROBLEM

The problems of known solutions can be substantially avoided by means of the present invention. The invention enables peeling substantially without water, a continuous product flow-through with uniform peeling and smooth discharge without throw members and without any impact damages of the peeled product.

This is achieved in accordance with the invention by providing a peeling machine according to the invention with the characterizing features disclosed in claim 1. The subsequent dependent claims disclose suitable further embodiments and variations of the invention that still improve the functioning of the invention.

In the following description, the terms “up”, “down”, “above”, “below” etc. refer to directions in relation to the peeling machine or its structural details as shown in the attached figures.

Advantages and details of the invention become apparent from the following description.

### BRIEF DESCRIPTION OF THE FIGURES

In the following, the invention is described in more detail with reference to the drawing, in which

FIG. 1 shows a peeling machine according to the invention as a vertical cross-section;

FIG. 2 shows a peeling machine according to FIG. 1 seen from above and as a partial cut-through;

FIG. 3 shows a peeling machine seen from above, illustrating different positioning options for the inlet opening;

FIG. 4 shows a particular embodiment of a suction arrangement fitted to a peeling plate of the peeling machine;

FIG. 5 shows an alternative peeling machine as a vertical cross-section;

FIG. 6 shows schematically a particular embodiment of a fan arrangement fitted to a peeling plate of the peeling machine;

FIG. 7 shows a vertical cross-section of a fan arrangement according to FIG. 6;

FIG. 8 shows an arrangement of a driving belt of the peeling machine; and

FIG. 9 shows an alternative arrangement of a driving belt of the peeling machine.

### PREFERRED EMBODIMENT

A preferred embodiment of the peeling machine is described in the following with reference to the above-mentioned figures. Hereby, the solution comprises the structural parts shown in the figures, each of which is designated with a corresponding reference numeral. These reference numerals correspond to the reference numerals given in the description below.

The present embodiment of the peeling machine is constructed on a substantially stationary frame 1, which is in this embodiment circular. This frame comprises an outer, substantially cylindrical drum 2 arranged vertically and an inner drum 3 parallel to the outer drum. Further, the frame comprises a planar, round bottom 4 arranged horizontally, substantially perpendicularly to the drums. The drums and the bottom together define a peeling space 5 that has a cross-section substantially corresponding to a circle.

The bottom 4 is provided with a plurality of circular openings 6 in the peeling space 5. Each of these openings is provided with a peeling plate 7 arranged to extend substantially over the whole opening, as can be seen in FIGS. 6 and 7. The peeling plate comprises, on its upper surface 8 directed towards the peeling space, a plurality of blades 9 arranged to extend substantially radially along the upper surface of the peeling plate, from its centre 10 towards its outer edge 11. The peeling plates advantageously have a somewhat inclined recess for the blades, whereby the front edges of the blades protrude to some extent from the upper surface of the peeling plate according to FIG. 7. The thickness of the skin to be peeled off can be advantageously adjusted with an appropriate base under the blades.

The peeling plate 7 comprises in connection with these blades 9 also through openings, i.e. peeling openings 12, arranged in front of each blade and intended for removing skin remains from the peeling space 5. The peeling opening advantageously extends over the whole length of the blade.

The peeling plates can also be completely or partially provided with a grinding coating known as such, for instance a silicon carbide coating. The number of peeling plates as well as the number of their blades can vary as required.

The peeling plate 7 is arranged to be rotatable in relation to the bottom of the peeling machine, whereby it is fixed to a shaft 13 and is operated to rotate by means of a driving member known as such, arranged at the shaft. The peeling plates can have rotation directions and speeds that deviate from each other.

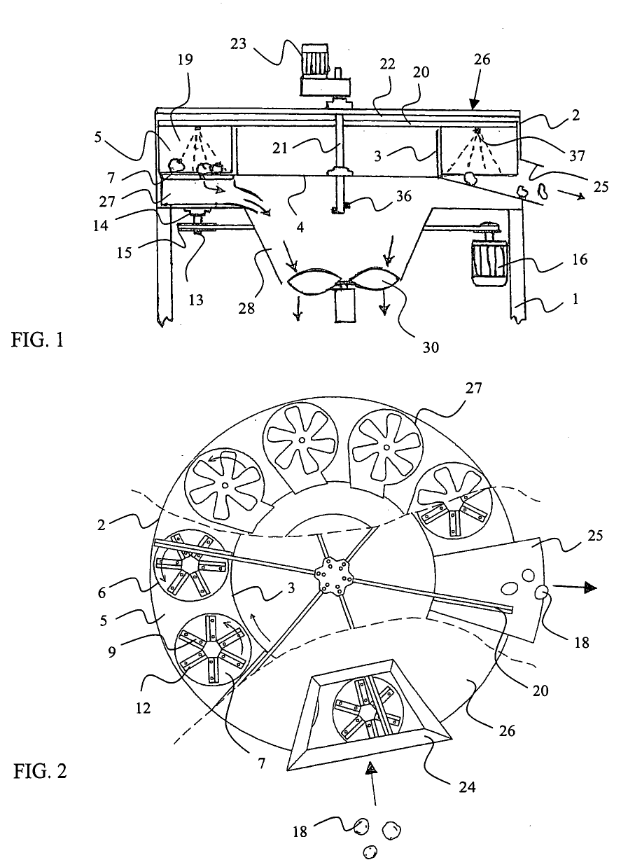

The driving member can be arranged at each of the shafts 13 of the peeling plates, or alternatively it can be common to all shafts according to FIG. 1, for example. In this embodiment, the shaft is mounted on a bearing in a bearing housing 14 in the frame. Lowest on the shaft there is, for example, a belt pulley 15 for operating the cutting unit formed by the peeling plate 7. Advantageously, the driving member 16 that transmits the rotation force via a driving belt 17 or driving chain to the cutting units has an adjustable speed.

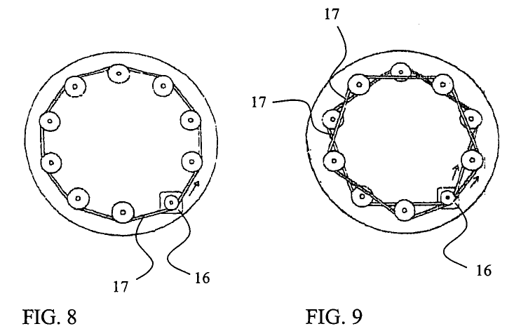

The belt pulleys 15 of the shaft 13 can be mounted on a common horizontal plane in accordance with FIG. 8. The belt pulleys can also be mounted in a mutually displaced position in the longitudinal direction of the shaft. Advantageously, the belt pulleys are in this embodiment on two parallel horizontal planes above each other according to FIG. 9. In the mounting of the belt pulleys on two parallel planes, the driving member comprises two parallel driving belts 17 or driving chains. In this embodiment the driving belts run over every other belt pulley. In this way, the belt has a longer contact surface and thus a better driving effect despite slacker tension. This saves energy and increases the durability of the driving belt.

To move the products to be peeled, i.e. the peeling product 18, forwards, the present peeling machine advantageously comprises in the peeling space 5 a reel 20 provided with a push plate 19. The reel is mounted, via a driving shaft 21, on a bearing as well in the middle of the bottom 4 of the frame 1 as on a load-bearing lattice 22 upon the inner drum 2 and the outer drum 3.

The reel's 20 or the force-feeding wheel's push plate 19 divides the enclosed peeling space 5 into a plurality of compartments. These compartments rotate slowly along the peeling space, which means that the compartments moving forwards often become positioned over two rotating peeling plates 7 during the peeling, which results in a rotating, rolling movement of the peeling product. This movement prevents the product from staying up, which would cause the product to be peeled too much. Now, by contrast, the peeling is uniform and the yield is high.

In addition, the reel 20 enables continuous product flow-through in the peeling machine, which makes the after-cleaning of the peeling product 18 significantly easier and eliminates the problem of portioning and the need for a portion scale. The reel is operated by a driving member 23 via the driving shaft 21. This driving member is advantageously speed-adjustable and can also be run in opposite directions.

The reel 20 is arranged to move the peeling product 18 forwards from an inlet 24 of the peeling machine towards the outlet 25 of the peeling machine to remove the peeling product from the machine.

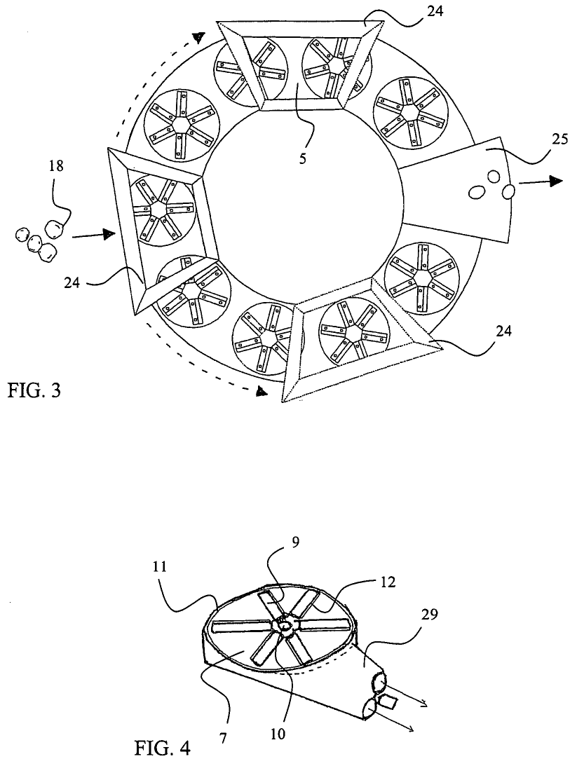

The inlet 24 is advantageously formed by a hopper that can be placed anywhere round the peeling space 5 in accordance with FIG. 3. By selecting different positions of the inlet in relation to the outlet, the peeling product can be subjected to longer or shorter peeling. By adjusting the peeling time in this way the capacity of the peeling machine can be regulated by simple means. The hopper of the inlet forms a part of a substantially circular cover plate 26 or grating arranged rotatably on the frame, whereby the position of the inlet is selected by rotating the cover plate in relation to the peeling space.

The outlet 25 is formed as a fixed part of the frame 1, whereby the bottom of the outlet has an inclination from the inner drum 2 outwards to extend to the outside of the outer drum 3. The outlet thus extends through the whole width of the peeling space, which means that the peeling product 18 rolls smoothly out of the machine.

To remove the peeling remains from the peeling space 5, the present peeling machine is provided with a suction arrangement 27 according to FIGS. 1 and 2. The purpose of this suction arrangement is to generate an underpressure at least in the vicinity of the peeling opening 12. The arrangement provides a powerfully sucking air current both through the peeling openings of the peeling plates, including their peripheries, and at possible openings between the outer edge 11 of the peeling plate and the bottom 4, to suck with it the peeling waste and other impurities down the space beneath the peeling plate and further to the middle of the peeling machine and a collecting hopper 28 therein.

An air current required for removing the peeling waste and impurities can advantageously be provided by arranging a hopper-shaped device 29 at each of the openings 6 at the bottom 4. Such a hopper is arranged tightly against the bottom, and suction is generated at the opposite end of the hopper. This suction can be provided with, for instance, a fan connected to the hopper, or an ejector connected thereto. The fan or the ejector can be placed separately on each of the peeling plates, but it is also feasible that the fan or the ejector is common to all peeling plates. In FIG. 1, the fan 30 is arranged in the bottom part of the collecting hopper 28.

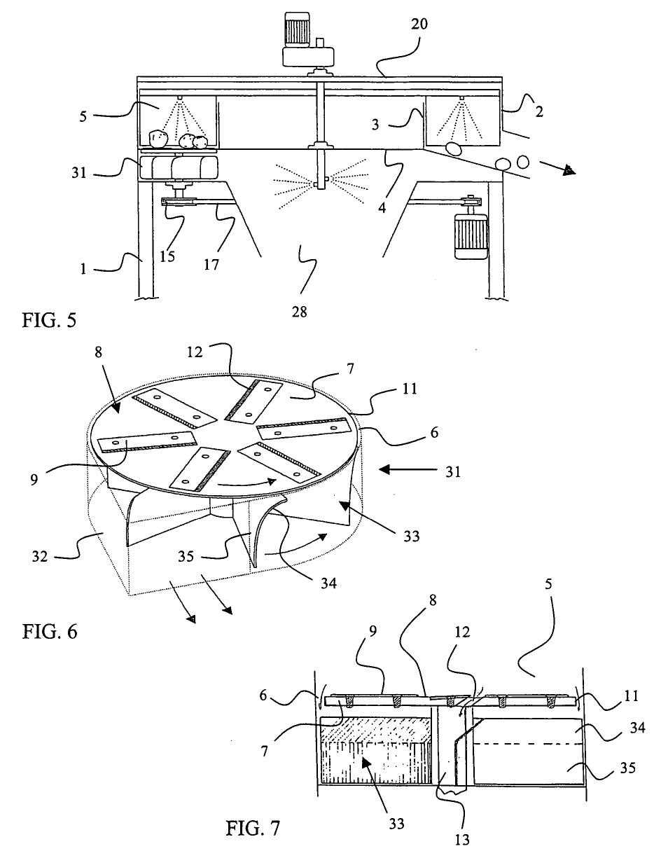

FIGS. 5 to 7 show an alternative embodiment of the suction arrangement 27. Hence, the shaft 13 of the peeling plate 7 comprises a combined propeller centrifugal fan 31, i.e. a combined fan.

The combined fan 31 with its fan housing 32 generates a powerfully sucking air current through the peeling openings 12 of the peeling plates 7 and the outer periphery of the peeling plates. This air current sucks with it the peeling waste and other impurities down the fan housing and to the middle part and collecting hopper 28 of the peeling machine. By inclining the peeling opening together with the blade 9 according to FIG. 7, an inward-sucking effect is generated which intensifies the effect of the outward-sucking air current.

The presented combined fan comprises a fan housing 32 below the peeling plate 7, positioned concentrically with it, and a fan blade 33. The fan blade obtains its driving force advantageously from the shaft 13 of the peeling plate, whereby the relative speed of the fan blade and the peeling plate may be varied.

The fan blade 33 is advantageously made up by a construction of two parts in its longitudinal direction. Hereby, the fan blade half directed towards the peeling plate 7 is formed as a substantially normal propeller fan blade 34, whereas the other half is formed as a centrifugal fan blade 35. Thus, the half directed towards the peeling plate functions as a propeller fan and generates powerful suction through the peeling plate, whereas the lower part removes peeling waste and other impurities flowing into the fan housing towards the collecting hopper 28.

This sucking air current generated with the suction arrangement 27 allows the peeling process to be carried out completely without water. Owing to the effective cleaning, the peeling space 5 remains very clean, and the quality and durability of the peeling product 18 are improved. In accordance with FIG. 2, the peeling machine can, however, be provided with water sprinklers 36 and 37 known as such to clean the interior of the peeling machine quickly and efficiently.

The above description and the related figures are only intended for illustrate the present solution for construction of a peeling machine. Therefore, the solution is not restricted to the above or to the embodiments described in the attached claims but a plurality of variations or alternative embodiments are feasible within the idea presented in the attached claims.

1. A peeling machine for root vegetables, fruits and the like peeling products, comprising a frame and a peeling space arranged therein, the peeling space including a number of blades and peeling openings provided with rotating peeling plates, which peeling plates are positioned in essentially round openings at the bottom of the circular peeling space, wherein the peeling machine comprises a suction arrangement arranged at the peeling plates and below them for generating an underpressure at least in the vicinity of the peeling opening, whereby
the suction arrangement is arranged at the openings at the bottom and directed towards a collecting hopper positioned below the peeling space to
generate an air current directed from the peeling space through the openings and the defining peeling plates to the collecting hopper.

2. A peeling machine according to claim 1, wherein the suction arrangement comprises a common fan for jointly serving all the peeling plates.

3. A peeling machine according to claim 1, wherein the suction arrangement comprises a fan arranged on the underside of each individual peeling plate.

4. A peeling machine according to claim 3, wherein the fan is arranged concentrically with the shaft of the peeling plate.

5. A peeling machine according to claim 4, wherein the fan comprises a combined propeller centrifugal fan.

6. A peeling machine according to claim 5, wherein the propeller centrifugal fan comprises a fan housing and a fan blade, the fan blade advantageously comprising a construction of two parts in its longitudinal direction, whereby the fan blade part directed towards the peeling plate is formed as a substantially normal propeller fan blade whereas the other half is formed as a centrifugal fan blade.

7. A peeling machine according to claim 1, wherein the peeling plates are completely or partially provided with a grinding coating.

8. A peeling machine according to claim 1, wherein the peeling machine comprises an inlet arranged to be displaceable around the whole peeling space for regulating the capacity of the peeling machine in this way.

9. A peeling machine according to claim 1, wherein the peeling machine comprises an outlet for removing the peeling products, whereby the outlet has an inclination of the bottom, extending over the whole width of the peeling space.

10. A peeling machine according to claim 1, wherein the peeling machine comprises a reel arranged rotatably therein and provided with one or more push plates arranged to force-feed the peeling product continuously from the inlet of the peeling machine over one or more peeling plates towards the outlet of the peeling machine.
